(19) United States
(12) Patent Application Publication
(10) Pub. No.: US 2011/0027434 A1
(43) Pub. Date: Feb. 3, 2011

(54) CANDY POPCORN COOKER AND MIXER, AND ASSOCIATED METHODS OF MANUFACTURE AND USE

(76) Inventor: Charles D. Cretors, Lake Forest, IL (US)

Correspondence Address: PERKINS COIE LLP;PATENT-SEA, P.O. BOX 1247, SEATTLE, WA, 98111-1247, US

(21) Appl. No.: 12/849,547

(22) Filed: Aug. 3, 2010

Related U.S. Application Data
(60) Provisional application No. 61/230,883, filed on Aug. 3, 2009.

(51) Int. Cl. A23L 1/18; A23L 1/01; A23P 1/08

(52) U.S. Cl. 426/290; 99/323.8; 426/450; 426/295

(57) ABSTRACT

An apparatus for cooking, mixing, and dispensing candy popcorn, and various methods of manufacture and use are disclosed. A vessel with a copper interior surface includes an agitator positioned at the bottom of the vessel. The agitator comprises a member that rotates around the bottom of the vessel to move the contents of the vessel. An auger with a helical surface is positioned in the vessel and is configured to rotate to mix popped popcorn with a candy mixture that has been cooked in the vessel. The vessel can be tilted manually or automatically to dispense the contents of the vessel.

### CROSS-REFERENCE TO RELATED APPLICATIONS

The present application claims priority to and the benefit of U.S. Provisional Application No. 61/230,883, filed Aug. 3, 2009 and titled CANDY POPCORN COOKER AND MIXER, AND ASSOCIATED METHODS OF MANUFACTURE AND USE, which is incorporated herein by reference in its entirety.

### TECHNICAL FIELD

The following disclosure relates generally to candy popcorn makers and, more particularly, to a caramel popcorn cooker/mixer and associated methods.

### BACKGROUND

Candy popcorn such as caramel popcorn, kettle corn, and other flavors of candy popcorn are widely enjoyed. Conventional methods of making candy popcorn requires cooking a candy mixture, popping the popcorn, then mixing the popcorn and the candy together. These steps were traditionally performed using separate containers specialized for each task. Popcorn is popped separately in popcorn poppers, the candy coating is cooked in copper kettles, and stainless steel mixers are used to mix the popcorn with the candy. This arrangement requires that once the corn is popped and the candy cooked, the hot candy and popcorn are transferred to a mixer, mixed, then transferred to a cooling and packaging station.

### BRIEF DESCRIPTION OF THE DRAWINGS

FIG. 1 is an isometric view of a popcorn cooker and mixer configured in accordance with an embodiment of the disclosure.

FIG. 2 is a top view of a popcorn cooker and mixer configured in accordance with an embodiment of the disclosure.

FIG. 3 is a front cut-away view of a popcorn cooker and mixer configured in accordance with an embodiment of the disclosure.

FIG. 4 is a side cut-away view of a popcorn cooker and mixer configured in accordance with an embodiment of the disclosure.

FIG. 5 is an isometric view of a popcorn cooker and mixer with a wire grate configured in accordance with an embodiment of the present disclosure.

### DETAILED DESCRIPTION

The following disclosure describes various embodiments of candy popcorn cookers/mixers, and associated methods of manufacture and use. Conventional candy popcorn mixers typically include a rotating container with a stationary or rotating mixer such as an auger, baffles, or other mixing mechanisms. Various types of mixing equipment are disclosed in U.S. Pat. No. 3,167,453, which is incorporated herein by reference in its entirety. Cooking the candy requires heating the candy, which is usually done by heating the container. Applying heat to a rotating container can pose difficulties when using conventional mixing equipment. Moreover, when using multiple containers for different steps, each transfer step requires care, skill, and time. Also, transferring hot candy materials between containers may cause the candy to cool more than is desirable during mixing. Accordingly, there is a need in the art for a cooker and/or a mixer that addresses these difficulties.

In one embodiment, a flavored popcorn cooker/mixer configured in accordance with the present disclosure includes a generally cylindrical vessel or pot with a copper interior surface, an agitator bar disposed at the bottom of the pot, and a vertically rotating auger positioned in the pot. In operation, the pot remains stationary while the agitator bar rotates in one direction and the auger rotates in an opposite direction. Flavoring ingredients such as caramel (e.g., sugar, water, and glucose), cheese, or other flavorings are placed in the pot. The pot is heated to cook the ingredients. Popped popcorn is then added and the agitator bar and auger mix the cooked flavoring mixture evenly over the popcorn. When the mixture is complete, the pot can be manually or automatically tilted to dispense the flavored popcorn mixture onto a cooling platform.

In some embodiments, the entire pot is constructed of copper, while in other embodiments a portion of the pot is constructed of another material, such as stainless steel, and the interior surface or a portion of the interior surface is coated with copper. In other embodiments, only the bottom surface of the pot is copper. The agitator bar can include an L-shaped arm that substantially matches the shape of the bottom of the pot such that the arm is configured to move the mixture at the bottom of the pot. According to some embodiments, the auger comprises a vertical shaft with a helical or spiral surface extending radially from the shaft. The auger is configured to rotate (e.g., to counter-rotate relative to the agitator bar) to mix the popcorn and the flavoring mixture to coat the popcorn with the flavoring mixture.

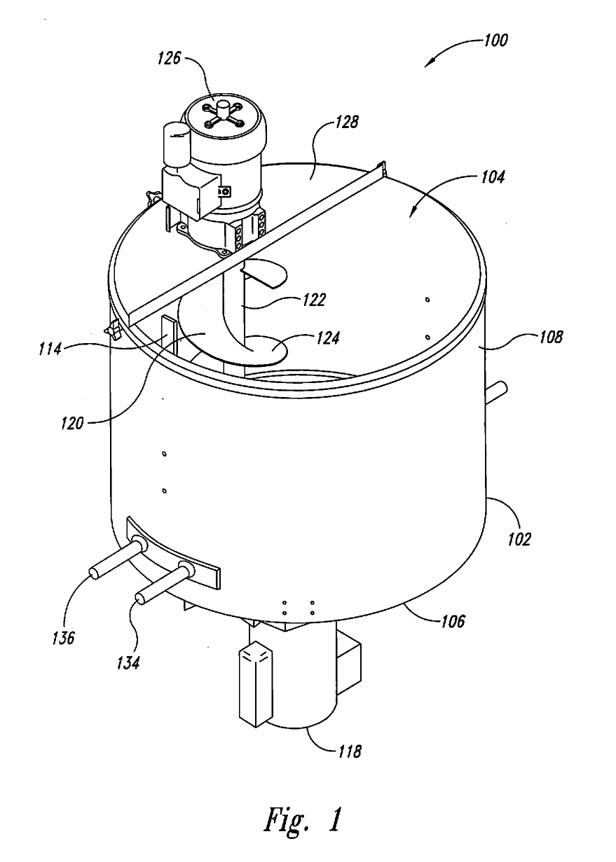

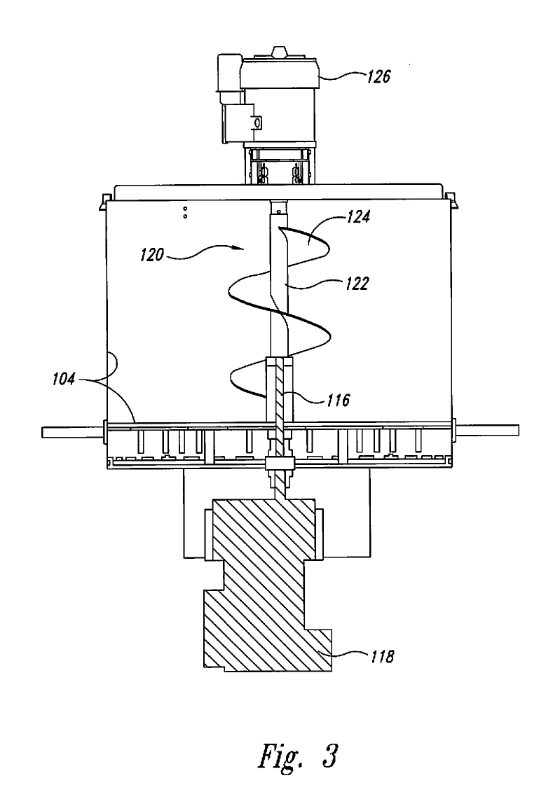

Certain details are set forth in the following description and in FIGS. 1-4 to provide a thorough understanding of various embodiments of the disclosure. Other details describing well-known structures and systems often associated with culinary and mixing equipment and methods for forming such parts (e.g., machining, forming, casting, polishing, finishing, etc.), as well as other cooking and mixing parts, assemblies and power sources, are not set forth in the following disclosure to avoid unnecessarily obscuring the description of the various embodiments of the disclosure.

Many of the details, dimensions, angles and/or other portions shown in the Figures are merely illustrative of particular embodiments of the disclosure. Accordingly, other embodiments can have other details, dimensions, angles and/or portions without departing from the spirit or scope of the present disclosure. In addition, further embodiments of the disclosure may be practiced without several of the details described below, while still other embodiments of the disclosure may be practiced with additional details and/or portions.

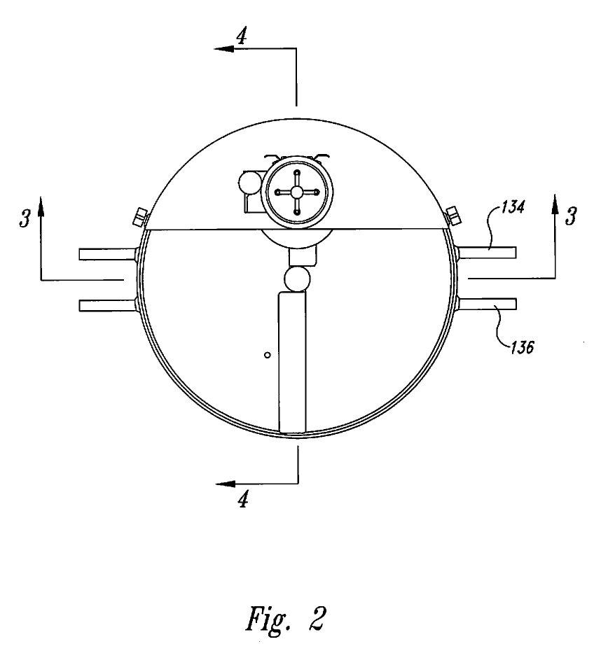

FIG. 1 is an isometric view of a candy popcorn cooker/mixer 100 configured in accordance with an embodiment of the disclosure. FIGS. 2, 3, and 4 are a top view, a front cut-away view, and a side cut-away view, respectively, of the candy popcorn cooker/mixer 100 shown in FIG. 1. Similar reference numerals are used to refer to similar features in each of FIGS. 1-4.

Referring to FIGS. 1-4 together, the cooker/mixer 100 includes a pot 102 with an interior surface 104. In one embodiment, the interior surface 104 is copper. In other embodiments, the interior surface 104 can be other materials that conduct heat evenly and can be used to cook sugar at high temperatures. The pot 102 is generally shaped with a flat bottom 106 and a cylindrical sidewall 108. Other configurations are also possible, including a rounded bottom and sides. In some embodiments, the entire pot 102 is constructed of copper; in other embodiments, the interior surface 104 of the pot 102 is coated completely or partially with copper. For example, a stainless steel or aluminum pot 102 can have a copper interior surface at the bottom. The sides of the pot 102 can be copper as well. Copper is generally considered to have desirable characteristics for cooking candy because it conducts heat evenly and reacts favorably with the ingredients for optimal candy making. The copper surface 104 is configured to be heated to cook candy and other flavors in the pot 102. Embodiments of the present disclosure provide a more effective and efficient cooking and mixing assembly because the candy can be cooked and mixed with the popcorn in the same pot 102.

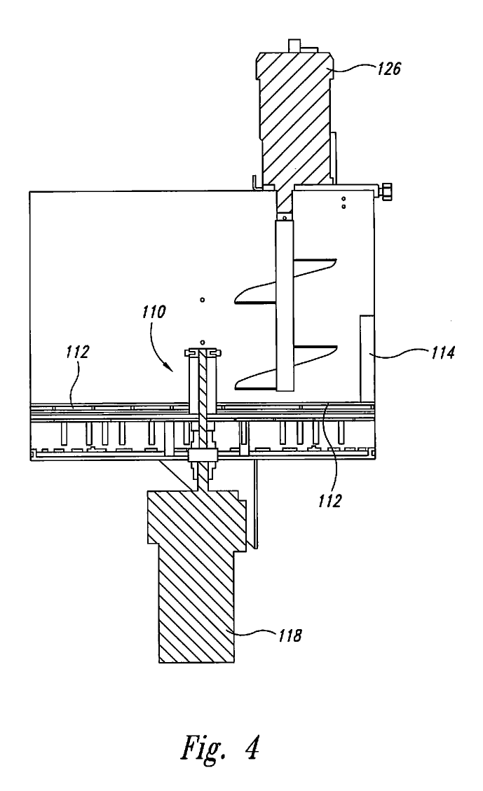

In another aspect of the illustrated embodiment, the cooker/mixer 100 includes an agitator 110 positioned in the bottom of the pot 102 that rotates about a pivot point (not shown). In this example with a flat bottom 106 and cylindrical walls 108, the agitator 110 includes a horizontal member or bar 112 and a vertical member or bar 114 connected at a right angle, as illustrated in FIG. 4. The agitator bars 112 and 114 can be configured to fit a wide variety of pots 102 having different shapes. For example, if the pot 102 had a rounded corner or a rounded bottom, the bars 112 and 114 can be rounded as well.

The arm 114 extends from the member 112 vertically along the side 108 of the pot 102. The arm 114 and member 112 act together to thoroughly move the candy mixture in the pot 102 to ensure proper mixing and to prevent burning the candy. The agitator 110 is connected to a shaft 116 in the center of the pot 102. A motor 118 is connected to the shaft 116 and causes the shaft 116 to rotate around the bottom of the pot 102 to cause the agitator 110 to rotate around the bottom of the pot 102 to move the mixture in the pot 102. While the illustrated embodiment has only one horizontal arm 112 and one vertical arm 114, other embodiments have two, three, four, or more horizontal arms 112 disposed at different angular positions about the shaft 116, each with a vertical agitator arm 114.

In one aspect of the disclosure, the cooker/mixer 100 includes an auger 120 comprising a shaft 122 and a blade 124 extending radially from the shaft 124. In some embodiments, the blade 124 can be a spiral or helical blade. The auger 120 is positioned generally vertically in the pot 102 and is connected to a motor 126 which causes the auger to rotate in the pot 102. In some embodiments a single motor can power both the agitator 110 and the auger 120. The power from the single motor can be transmitted to the agitator 110 and the auger 120 through a series of gears, pulleys, shafts, and other well-known means of transmitting power. The auger 120 can be positioned at a center of the pot 102, or can be offset to one side of the pot 102 such as toward the rear of the pot 102 as shown in FIGS. 1, 2, and 4. The auger 120 rotates in the pot 102 in a direction in which the spiral surface 124 lifts the popcorn in the pot 102 and mixes the popcorn with the candy mixture. In some embodiments, the auger 120 and the agitator 110 are configured to rotate in opposite directions (e.g., the auger moving clockwise and the agitator 110 moving counter-clockwise, or vice versa), or in the same direction. The auger 120 can be removable from the pot 102, or fixed to the pot 102. In some embodiments, the agitator 110 helps to move the popcorn and candy mixture into the auger 120 to thoroughly mix the popcorn with the candy mixture.

The pot 102 is pivotably connected to a base (not shown) by a shaft 134. To create stability, the center of gravity of the cooker/mixer assembly 100 (including the pot 102, the motors 118, 126, and the candy/popcorn mixture) is offset slightly from the shaft 134 such that during operation the cooker/mixer 100 will remain level and upright. A lifting lever 136 is offset from the shaft 134 to provide leverage for tilting the pot 102 to empty the contents of the pot 102. A handle (not shown) can be attached to the lifting lever 136 to provide even greater leverage and access. Lifting the lifting lever tilts the pot 102 to pour the contents of the pot 102 out of the pot 102 onto a cooling surface or into another container.

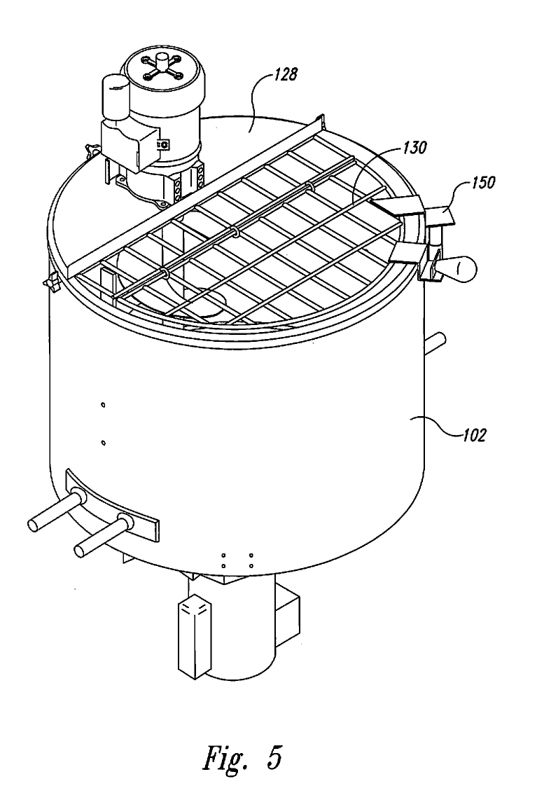

FIG. 5 illustrates an embodiment in which a pot 102 can contain a lid 128 which can be a partial lid or a full lid with a hinged section. In some embodiments, the auger 120 and motor 126 can be suspended above the pot 102 by a bar or platform (not shown) and not with a lid 128. In some embodiments the lid 128 is a solid metal sheet, while in other embodiments the lid 128 is a grate such as a metal mesh or wire grate 130. An automatic shut-off system 150 can be included with the cooker/mixer 100 such that if the lid 128 (or a portion thereof, such as the grate 130) is opened during operation of the cooker/mixer 100, one or more of the agitator 110, the auger 120, or the heating mechanism (not shown) will shut off. The automatic shut-off system 150 can be an optical system where opening the lid 128 either interrupts or ceases to interrupt a light beam, a mechanical system where opening the lid 128 mechanically prevents operation of the cooker/mixer, or an electrical system where opening the lid 128 either closes or opens an electrical switch to interrupt operation of the cooker/mixer 128. In other embodiments the automatic shut-off system 150 includes a combination of optical, mechanical, and electrical components.

In some embodiments, the popcorn coating can be cooked in the cooker/mixer 100 before adding the popcorn. The ingredients for the mixture can be placed in the pot 102 and heated (heat source not shown) to an appropriate temperature such as a hard crack temperature (e.g., approximately 300° Fahrenheit). In some embodiments, a lower temperature can be used to melt and apply cheese which generally requires a lower temperature. The cooker/mixer 100 can be adjusted to any temperature to accommodate any material additive to popcorn. A powder flavoring mix and a light oil coating, for example, can be added to popped popcorn and mixed in the cooker/mixer 100 and cooked at appropriate temperatures and for an appropriate time. The pot 102 is stationary and accordingly can be heated with electrical heaters, gas-fired heaters, or other equivalent means for heating a pot. When the coating is cooked, the popcorn can be added to the pot 102 and mixed with the coating. A surfactant such as lecithin can be added to the mixture to ease handling of the candy popcorn. In alternative embodiments, the popcorn and the candy ingredients can be added substantially simultaneously and the candy can be cooked while mixing with the popcorn. The cooker/mixer 100 provides for a significantly faster and easier cooking and mixing process than conventional methods.

From the foregoing, it will be appreciated that specific embodiments of the disclosure have been described herein for purposes of illustration, but that various modifications may be made without deviating from the spirit and scope of the various embodiments of the disclosure. While various advantages associated with certain embodiments of the disclosure have been described above in the context of those embodiments, other embodiments may also exhibit such advantages, and not all embodiments need necessarily exhibit such advantages to fall within the scope of the disclosure. The following claims are directed to various embodiments of the disclosure.

1. A popcorn maker, comprising:
a container having an interior wall portion and a base configured to receive unpopped popcorn and one or more flavoring ingredients;
a popcorn lifter suspended above the base, the auger including a blade configured to move within the container;
an agitator positioned toward the base of the container, the agitator having an arm extending radially outwardly from a pivot point along the base of the container, wherein the arm is configured to rotate about the pivot point; and
a heat source configured to heat the container and pop the popcorn, wherein the agitator arm and the blade are configured to coat the popcorn with the one or more flavoring ingredients.

2. The popcorn maker of claim 1 wherein at least a portion of the container comprises a copper cooking surface.

3. The popcorn maker of claim 1 wherein the helical blade is configured to rotate in a direction that lifts the popcorn upwardly and away from the base.

4. The popcorn maker of claim 1 wherein the agitator is configured to rotate in an opposite direction from the auger.

5. The popcorn maker of claim 1 wherein the heat source is configured to deliver sufficient heat to pop the popcorn in the container, and wherein the auger and agitator are configured to counter-rotate at a sufficient speed to mix the one or more flavoring ingredients over the popcorn such that the popcorn is popped and flavored within the container.

6. The popcorn maker of claim 1, further comprising:
a lid over the container; and
a sensor operably coupled to the lid and configured to sense when the lid is not in a closed position.

7. The popcorn maker of claim 6, further comprising a control mechanism configured to receive a signal from the sensor indicating that the lid is not in the closed position and to cease at least one of rotation of the agitator, rotation of the auger, or heating from the heat source in response to the signal.

8. The popcorn maker of claim 1 wherein the base of the container is at least generally circular, and the auger is positioned between the pivot of the agitator and the wall portion of the container.

9. The popcorn maker of claim 1 wherein the arm comprises an L-shaped arm with a first portion extending along the base of the container and a second portion extending upward against the wall portion of the container.

10. The popcorn maker of claim 9 wherein the arm comprises a plurality of L-shaped arms.

11. The popcorn maker of claim 1 wherein the blade comprises a spiral blade or a helical blade.

12. A method of making popcorn, comprising:
placing unpopped popcorn into a container of a popcorn maker, the popcorn maker having an agitator arm positioned toward a base of the container;
placing one or more flavoring ingredients into the container;
rotating the agitator arm around the base of the container to mix the popcorn and the flavoring ingredients together;
rotating an auger in the container, the auger having a blade that lifts the popcorn upwardly away from the base of the container; and
heating the container to pop the popcorn within the container.

13. The method of claim 12 wherein placing the flavoring ingredients includes placing sugar in the container, and wherein heating the container comprises heating the sugar in the container to a hard crack temperature.

14. The method of claim 12, further comprising after the popcorn is popped and coated with the flavoring ingredients, depositing the popcorn onto a cooling sheet.

15. A popcorn cooker, comprising:
a container having a generally circular base and a generally cylindrical wall portion extending upwardly therefrom;
a heat source configured to heat the container to cook sugar to a hard crack temperature;
an agitator configured to rotate about a pivot point positioned at a center of the base, the agitator comprising an L-shaped arm having a first portion extending generally along the base of the container and a second portion extending from the first portion adjacent to the wall portion of the container;
means for mixing popcorn in the container as the heat source heats the to pop the popcorn in the container;
an auger suspended above the base and having a blade extending downwardly into the container;
means for lifting popped popcorn in an upward direction and away from the base of the container to mix the popped popcorn with a flavoring ingredient; and
a motor operably coupled to at least one of the agitator and the auger.

16. The popcorn cooker of claim 15, further comprising:
a lid over the container; and
an auto-shutoff mechanism comprising a sensor and a control system, wherein the sensor is configured to detect that the lid is not in a closed position and to trigger the control system to cease operation of at least one of the heat source, the agitator, or the auger.

17. The popcorn cooker of claim 15 wherein the lid comprises a wire mesh grate.

18. The popcorn cooker of claim 15 wherein the agitator comprises a plurality of arms.

19. The popcorn cooker of claim 15 wherein the container is fixed to a rotating shaft, and wherein contents of the container can be poured from the container by rotating the container on the rotating shaft.

20. The popcorn cooker of claim 15 wherein a surface of the base and the wall portion comprises copper.

21. The popcorn cooker of claim 15 wherein the sensor comprises at least one of an optical sensor, a mechanical sensor, or an electronic sensor.
